(19) United States
(12) Patent Application Publication
(10) Pub. No.: US 2017/0173891 A1
(43) Pub. Date: Jun. 22, 2017

(54) GRAVITATIONAL SUPPORTS IN ADDITIVE MANUFACTURING SYSTEM

(71) Applicant: Stratasys, Inc., Eden Prairie, MN (US)

(72) Inventors: Michael D. Bosveld, Bloomington, MN (US); Amy Nicole Sissala, Minneapolis, MN (US); Robert E. Styer, Apple Valley, MN (US)

(21) Appl. No.: 14/976,910

(22) Filed: Dec. 21, 2015

(51) Int. Cl. B29C 67/00

(52) U.S. Cl. CPC B29C 67/0092; B29C 67/0055; B29C 67/0088; B33Y 50/02

(57) ABSTRACT

An additive manufacturing system for printing three-dimensional parts, the system including a print head configured to print a part material along a non-vertical printing axis, a non-horizontal print foundation configured to receive the printed part material from the print head to produce the three-dimensional part in a layer-by-layer manner, a drive mechanism configured to index the print foundation along the non-vertical printing axis, and a controller operably coupled to control the print head and the drive mechanism. The controller is configured to cause the print head to print the part according to a method of printing including printing a support structure below the part on the non-horizontal print foundation, wherein the part and the support structure are physically separated, and wherein the support structure is configured to support the part during printing as the part is elongated.

### BACKGROUND

The present disclosure relates to additive manufacturing systems for building three-dimensional (3D) parts with layer-based, additive manufacturing techniques. In particular, the present disclosure relates to additive manufacturing systems for printing large 3D parts, and methods for printing 3D parts in the additive manufacturing systems.

Additive manufacturing systems are used to print or otherwise build 3D parts from digital representations of the 3D parts (e.g., AMF and STL format files) using one or more additive manufacturing techniques. Examples of commercially available additive manufacturing techniques include extrusion-based techniques, jetting, selective laser sintering, powder/binder jetting, electron-beam melting, and stereolithographic processes. For each of these techniques, the digital representation of the 3D part is initially sliced into multiple horizontal layers. For each sliced layer, one or more tool paths are then generated, which provides instructions for the particular additive manufacturing system to print the given layer.

For example, in an extrusion-based additive manufacturing system, a 3D part may be printed from a digital representation of the 3D part in a layer-by-layer manner by extruding a flowable part material. The part material is extruded through an extrusion tip or nozzle carried by a print head of the system, and is deposited as a sequence of roads on a substrate in an x-y plane while the print head moves along the tool paths. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation.

In fabricating 3D parts by depositing layers of a part material, supporting layers or structures are typically built underneath overhanging portions or in cavities of 3D parts under construction, which are not supported by the part material itself. A support structure may be built utilizing the same deposition techniques by which the part material is deposited. The host computer generates additional geometry acting as a support structure for the overhanging or free-space segments of the 3D part being formed. Support material is then deposited from a second nozzle pursuant to the generated geometry during the printing process. The support material adheres to the part material during fabrication, and is removable from the completed 3D part when the printing process is complete.

### SUMMARY

An aspect of the present disclosure is directed to a method of printing a three-dimensional part in a horizontal additive manufacturing system. The method includes printing the three-dimensional part in a layer-by-layer manner in a substantially vertical build plane, and printing a support structure below the three-dimensional part in the substantially vertical build plane. Layers of the three-dimensional part and layers of the support structure are physically separated when printed, and wherein the support structure is configured to support the three-dimensional part during printing as the part is elongated during the printing process.

Another aspect of the present disclosure is directed to an additive manufacturing system for printing three-dimensional parts. The system including a print head configured to print a part material along a non-vertical printing axis and includes a non-horizontal print foundation configured to receive the printed part material from the print head to produce the three-dimensional part in a layer-by-layer manner. The system includes a drive mechanism configured to index the print foundation and the part along the non-vertical printing axis, and a controller operably coupled to control the print head and the drive mechanism. The controller further configured to cause the print head to print the part according to a method including printing a support structure below the part on the non-horizontal print foundation, wherein the layer of the part and the layer of the support structure are physically separated when printed, and wherein the support structure is configured to support the part during printing as the part is elongated during the printing process.

Another aspect of the present disclosure is directed to a computer program product. The product includes a non-transitory computer usable medium having a computer readable program code embodied therein. The computer readable program code is adapted to implement a method for printing in a horizontal additive manufacturing system, by printing a part in a layer-by-layer manner in a substantially vertical build plane, and printing a support structure below the part in the substantially vertical build plane, wherein the layer of the part and the layer of support structure are physically separated, and wherein the support structure is configured to support the part during printing as the part is elongated during the printing process.

### DEFINITIONS

Unless otherwise specified, the following terms as used herein have the meanings provided below:

The terms “about” and “substantially” are used herein with respect to measurable values and ranges due to expected variations known to those skilled in the art (e.g., limitations and variabilities in measurements).

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, such as along a horizontal x-axis or y-axis, the terms “above”, “below”, “top”, “bottom”, and the like are relative to the given axis. Furthermore, in embodiments in which the printed layers are planar, the printing axis is normal to the build plane of the layers.

The term “printing onto”, such as for “printing a 3D part onto a print foundation” includes direct and indirect printings onto the print foundation. A “direct printing” involves depositing a flowable material directly onto the print foundation to form a layer that adheres to the print foundation. In comparison, an “indirect printing” involves depositing a flowable material onto intermediate layers that are directly printed onto the receiving surface. As such, printing a 3D part onto a print foundation may include (i) a situation in which the 3D part is directly printed onto to the print foundation, (ii) a situation in which the 3D part is directly printed onto intermediate layer(s) (e.g., of a support structure), where the intermediate layer(s) are directly printed onto the print foundation, and (iii) a combination of situations (i) and (ii).

The term “providing”, such as for “providing a chamber” and the like, when recited in the claims, is not intended to require any particular delivery or receipt of the provided item. Rather, the term “providing” is merely used to recite items that will be referred to in subsequent elements of the claim(s), for purposes of clarity and ease of readability.

All patents, publications, applications or other documents mentioned herein are incorporated by reference in their entireties.

### BRIEF DESCRIPTION OF THE DRAWINGS

FIG. 1 is a side view of a 3D part being printed with a gravitational support, illustrating a horizontal printing axis, according to an embodiment of the present disclosure.

FIG. 2 is a perspective view of a 3D part and a plurality of gravitational supports according to an embodiment of the present disclosure.

FIG. 3 is a front elevation view of the 3D part of FIG. 2 taken along lines 3-3 thereof.

FIG. 4 is an enlarged view of a portion of the view of FIG. 3.

FIG. 5 is a close-up view of a portion of the embodiment of FIG. 3 showing a 3D part resting on gravitational supports.

FIG. 6 is an enlarged view of a portion of the view of FIG. 5.

FIG. 7 is a perspective view of a 3D part and a single gravitational support according to an embodiment of the present disclosure.

FIG. 8 is an enlarged view of a portion of the view of FIG. 7.

FIG. 9 is an enlarged view of a portion of a gravitational support according to another embodiment of the present disclosure.

### DETAILED DESCRIPTION

The present disclosure is directed to an additive manufacturing system having an extended printing volume for printing long or tall 3D parts. The additive manufacturing system optionally includes a heating mechanism configured to heat a build region of the system, such as a chamber having a port that opens to ambient conditions outside of the chamber. The system also includes one or more print heads configured to print a 3D part in a layer-by-layer manner onto a print foundation (e.g., a platen or other component having a receiving surface) in the heated chamber or other build region. However, the present disclosure is not limited to an additive manufacturing system with a heated build chamber. Rather, the present disclosure can be utilized with any additive manufacturing system that prints elongated parts, including out of oven systems having an open build environment or an unheated chamber with a port through which the part can extend.

As the printed 3D part grows on the print foundation, the print foundation may be indexed or otherwise moved in the build environment and/or through the port. The printed 3D part may continue to grow until a desired length and/or height is achieved. The use of the port in systems having a controlled build environment expands the available length of a printing axis of the system, allowing long or tall 3D parts, such as airfoils, manifolds, fuselages, and the like to be printed in a single printing operation. As such, the 3D parts may be larger than the dimensions of the additive manufacturing system.

As discussed further below, the additive manufacturing system may be configured to print 3D parts in a horizontal direction, a vertical direction, or along other orientations (e.g., slopes relative to the horizontal and vertical directions). In each of these embodiments, the layers of a printed 3D part may be stabilized by one or more printed “scaffolds”, which brace the 3D part laterally relative to the printing axis of the system to address forces parallel to the build plane. This is in comparison to a printed “support structure”, which supports a bottom surface of the 3D part relative to the printing axis of the system to address forces that are normal to the build plane (e.g., functions as an anchor for subsequent printed layers to reduce distortions and curling).

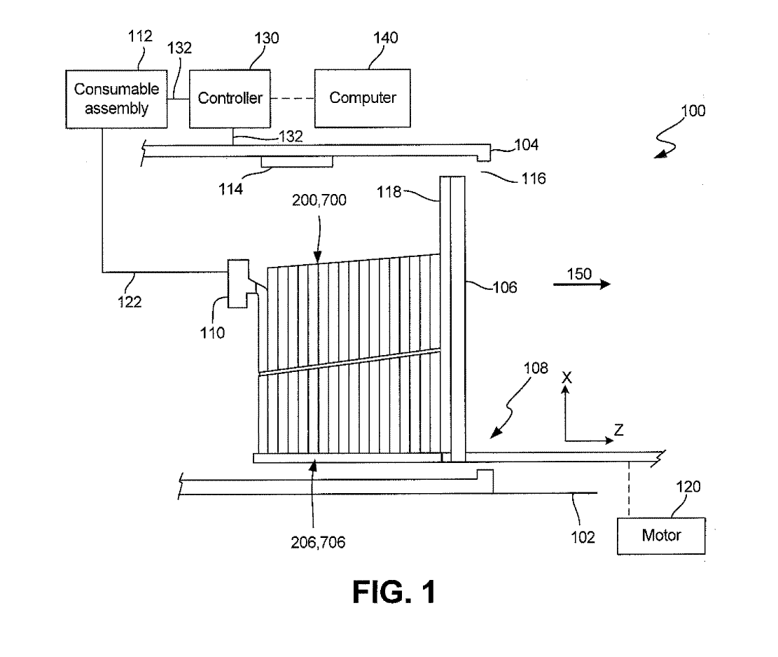

By way of example, FIG. 1 shows 3D part 200,700 being printed in a layer-by-layer manner from a nozzle of print head 110, where the layers of the 3D part 200,700 grow horizontally along the z-axis. As such, the “printing axis” in FIG. 1 is a horizontal z-axis axis, and each layer extends parallel to a vertical x-y build plane (y-axis not shown).

FIG. 1 illustrates an exemplary additive manufacturing system of the present disclosure having extended printing volumes for printing long 3D parts horizontally, such as discussed above for 3D part 200,700. FIG. 1 illustrates system 100, which is an exemplary additive manufacturing system for printing or otherwise building 3D parts and gravitational supports horizontally using a layer-based, additive manufacturing technique. Suitable systems for system 100 include extrusion-based additive manufacturing systems developed by Stratasys, Inc., Eden Prairie, Minn. under the trademark “FDM”, which are oriented such that the printing z-axis is a horizontal axis.

As shown in FIG. 1 system 100 may rest on a table or other suitable surface 102, and includes chamber 104, platen 106, platen gantry 108, print head 110, head gantry 42, and consumable assembly 112. Chamber 104 is an enclosed environment having chamber walls, and initially contains platen 106 for printing 3D parts (e.g., 3D part 200,700) and gravitational supports 206, 706. Additionally, while not shown, geometric support structures may also be printed by system 100.

In the shown embodiment, chamber 104 includes heating mechanism 114, which may be any suitable mechanism configured to heat chamber 104, such as one or more heaters and air circulators to blow heated air throughout chamber 104. Heating mechanism 114 may heat and maintain chamber 104, at least in the vicinity of print head 110, at one or more temperatures that will slow the rate of solidification of the part and support material to reduce distortion and curling of the material after being extruded and deposited (e.g., to reduce distortions and curling), as is disclosed in Batchelder et al., U.S. Pat. No. 5,866,058, and promote interlayer adhesion. However, depending upon the system and materials used, the chamber may not be heated, or the part may be built in an out of oven environment.

The chamber walls maybe any suitable barrier to reduce the loss of the heated air from the build environment within chamber 04, and may also thermally insulate chamber 104. As shown, chamber 104 includes port 116 extending laterally therethrough to open chamber 104 to ambient conditions outside of system 100.

In some embodiments, system 100 may be configured to actively reduce the heat loss through port 116, such as with an air curtain, thereby improving energy conservation. Furthermore, system 100 may also include one or more permeable barriers at port 116, such as insulating curtain strips, a cloth or flexible lining, bristles, and the like, which restrict air flow out of port 116, while allowing platen 106 to pass therethrough. In alternative embodiments, chamber 104 may be omitted, and system 100 may incorporate an open heatable region without chamber walls. For example, heating mechanism 116 may heat the heatable region to one or more elevated temperatures, such as with hot air blowers that direct the hot air towards (or in the vicinity of) print head 110. As in other embodiments, depending upon the system and materials used, the chamber may not be heated, or the part may be built in an uncontrolled environment.

Platen 106 is a print foundation having build or receiving surface 118, where 3D part 200,700 and gravitational support(s) 206,706 are printed horizontally in a layer-by-layer manner onto receiving surface 118. In some embodiments, platen 106 may also include a flexible polymeric film or liner, or other substrate or layer, which may function as receiving surface 118. Platen 106 is supported by platen gantry 108, which is a gantry-based drive mechanism configured to index or otherwise move platen 106 along the printing z-axis as illustrated in FIG. 1. Platen gantry 108 in one embodiment includes a drive motor 120 to provide power to index the platen gantry 108 along the z-axis.

In the shown example, print head 110 is an extruder configured to receive consumable particles, filaments or other materials from consumable assembly 112 (e.g., via tube 122) for printing 3D part 200,700 and gravitational support(s) 206, 706 onto receiving surface 118 of platen 106. Examples of suitable devices for print head 110 include an auger-based viscosity pump which is configured to print from particle part and/or support materials (e.g., pellets or powder-based materials), such as those disclosed in Batchelder et al., U.S. Pat. Nos. 5,312,224 and 8,955,558, and filament-fed print heads such as those disclosed in Crump et al., U.S. Pat. No. 5,503,785; Swanson et al., U.S. Pat. No. 6,004,124; LaBossiere, et al., U.S. Pat. Nos. 7,384,255 and 7,604,470; Leavitt, U.S. Pat. No. 7,625,200; Batchelder et al., U.S. Pat. No. 7,896,209; and Comb et al., U.S. Pat. No. 8,153,182. In some embodiments, an auger-based viscosity pump is incorporated into print head 110, which is configured to print from particle part and/or support materials (e.g., powder-based materials). Examples of suitable viscosity pumps for print head 110 include those disclosed in Batchelder et al., U.S. Pat. Nos. 5,312,224 and 8,955,558, which are configured to receive particle materials. Bosveld et al., U.S. Pat. No. 8,955,558 is incorporated by reference herein to the extent that it does not conflict with the present disclosure.

Consumable assembly 112 may supply particles, filament materials, slugs, or pre-melted materials to print head 110. In particle-fed embodiments, suitable devices for consumable assembly 112 include hopper-feeds such as disclosed in U.S. Pat. No. 8,955,558. In filament-fed embodiments, suitable devices for consumable assembly 112 include those disclosed in Swanson et al., U.S. Pat. No. 6,923,634; Comb et al., U.S. Pat. No. 7,122,246; Taatjes et al, U.S. Pat. Nos. 7,938,351 and 7,938,356; Swanson, U.S. Pat. No. 8,864,482; and Mannella et al., U.S. patent application Ser. Nos. 13/334,910 and 13/334,921.

System 100 also includes controller 130, which is one or more control circuits configured to monitor and operate the components of system 130. For example, one or more of the control functions performed by controller 130 can be implemented in hardware, software, firmware, and the like, or a combination thereof. Controller 130 may communicate over communication lines 132 with chamber 104 (e.g., heating mechanism 114), print head 110, consumable assembly 112, motor 120, and various sensors, calibration devices, display devices, and/or user input devices.

In some embodiments, controller 130 may also communicate with one or more of platen 106, platen gantry 108, and any other suitable component of system 100. While illustrated as a single signal line, communication line 132 may include one or more electrical, optical, and/or wireless signal lines, allowing controller 130 to communicate with various components of system 100. Furthermore, while illustrated outside of system 100, controller 130 and communication line 132 are desirably internal components to system 100.

System 100 and/or controller 130 may also communicate with computer 40, which is one or more computer-based systems that communicates with system 100 and/or controller 30, and may be separate from system 100, or alternatively may be an internal component of system 100. Computer 40 includes computer-based hardware, such as data storage devices, processors, memory modules and the like for generating and storing tool path and related printing instructions. Computer 140 may transmit these instructions to system 100 (e.g., to controller 30) to perform printing operations.

During operation, controller 130 may direct print head 110 to selectively extrude the part and support materials supplied from consumable assembly 112 or carried by print head 110. Print head 110 thermally melts the successive segments of the received materials such that they become molten flowable materials. The molten flowable materials are then extruded and deposited from print head 110, along the printing z-axis axis, onto receiving surface 118 for printing 3D part 200,700 (from part material) and gravitational support(s) 206,706(from support material and/or part material) where the support 206, 706 does not contact the part 200,700 in the print plane.

After each layer is printed, controller 130 may direct platen gantry 108 to index platen 106 along the z-axis in the direction of arrow 150 by a single layer increment. Alternatively, multiple layers of part 200,700 and gravitational support(s) 206,706 may be printed, and the platen 106 then indexed.

FIG. 1. also illustrates 3D part 200,700, gravitational support(s) 206,706 and platen 106 during the printing operation. The printing operation may continue until the last layer of 3D part 200,700 is printed and/or when platen 106 is fully indexed to the end of platen gantry 108. As can appreciated, allowing platen 106 to move out of chamber 104 increases the lengths of 3D parts that may be printed by system 100 compared to additive manufacturing systems having enclosed chambers.

After the printing operation is completed, the printed 3D part 200,700, gravitational support 206,706, and platen 106 may be removed from system 100 (e.g., by disengaging platen 106 from platen gantry 108). Platen 106 may then be removed from the part 200,700 and the gravitational support 206,706. As the gravitational support 206,706 is not physically connected to the part 200,700 during the printing process, the part 200,700 and the gravitational support 206,706 are not connected after removal from the platen 106.

Prior gravitational supports have physical connections to the parts they support when printed, such as with a bead or weak bond between the part and the support. The bead or weak bond is then broken away, following which the part is subjected to post processing to clean up any ridges or abnormalities due to the bead/connection between the support and the part. Alternatively, the part is built with a support structure that is of a different material than that of the part, and once a build is complete, the part and support structure are subjected to a bath that melts the support structure away. Each of these solutions requires post-processing, including time, equipment, and facilities.

Embodiments of the present disclosure provide a part that uses no additional post processing beyond what is already performed on all parts, as there is no permanent or semi-permanent contact between the gravitational support and the part itself. A gravitational support is in one embodiment printed at a position a distance below the low terminus of a part that is subject to gravitational sagging as it elongates while being printed, as described further below.

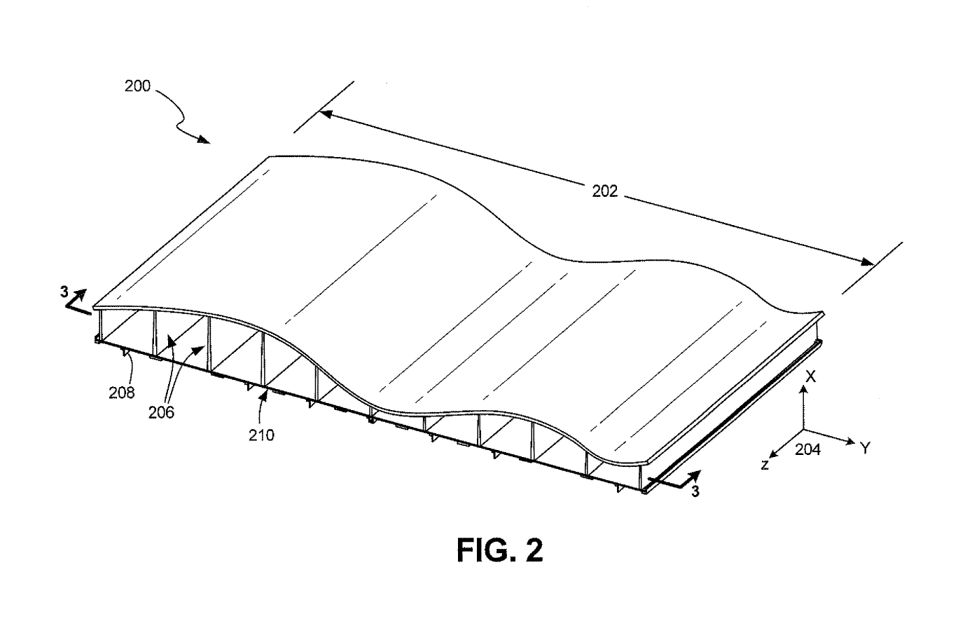

Referring to FIG. 2, a part 200 is shown in the process of being printed with an additive manufacturing machine such as 100. Part 200 has a width 202 extending in the Y direction as shown by orthogonal reference 204. Gravitational supports 206 are printed, using starter pieces as a base at the platen 106, and supports 206 are supported by printed extensions of starter pieces and keel structure 210, and extend upwardly in the X direction toward the part 200.

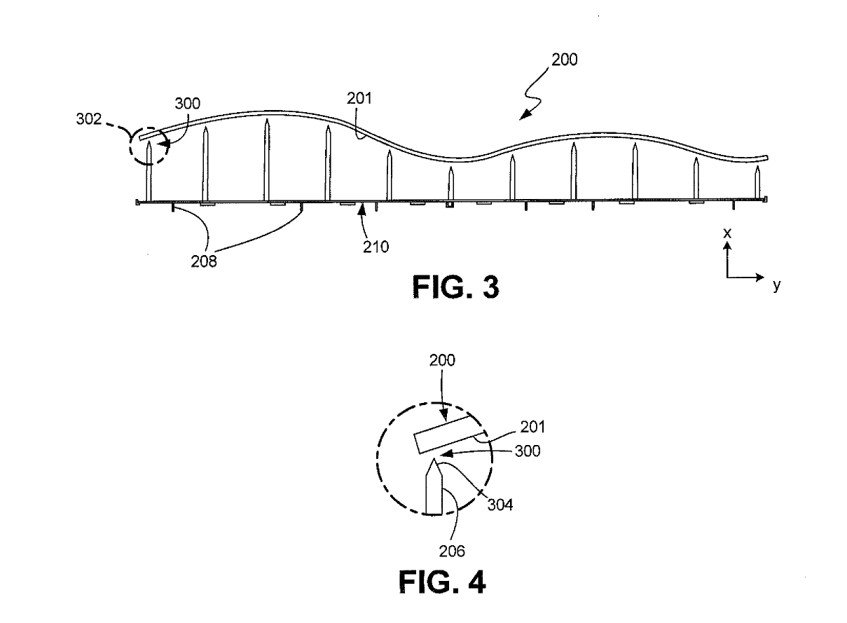

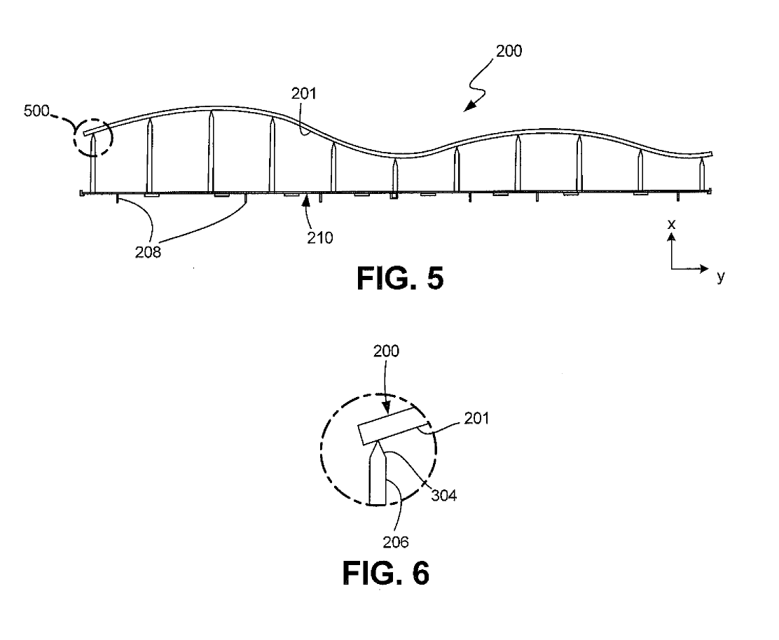

Referring now also to FIG. 3, printing of the part 200 and its gravitational supports 206 is performed such that at the print head, where the part 200 and gravitational supports 206 are being built in layer-by-layer fashion, a gap 300 is present between the part 200 and the gravitational supports 206 in the print plane. This gap 300 is shown in greater detail in FIG. 4, which is an enlarged portion 302 of FIG. 3. The gap 300 between the part 200 and the gravitational supports 206 is sufficiently sized in the print plane that the part 200 and the gravitational supports 206 do not touch. As the part 200 is built, portions of the part 206 that are farther from the X-Y print plane are affected by gravity, and can sag in the X direction. At this point, the part 206 may rest on top ends 209 of the gravitational supports 206, but without a permanent or semi-permanent connection thereto, as is shown in FIG. 5.

FIGS. 2-6 show a wide part 200 with a width 202. For wide parts such as part 200, a plurality of gravitational supports 206 are spaced along the width 202, in one embodiment approximately every five inches. A spacing of approximately every five lateral inches assist in the prevention of bowing or sagging of the part 200 while the part 200 is cooling. As the gravitational supports 206 for wide parts such as part 200 are spaced at intervals of approximately five inches, the contact area 304 of the tops of the supports 206 is in one embodiment very small, such as a point or small area that will eventually contact and support the lower surface 201 of part 200. This is because the forces of the part 200 on the supports 206 will be low. While a specimen of about five inches is discussed, the present disclosure is not limited to any particular spacing.

The supports in one embodiment are grown from starter pieces 208 and keel structure 210. Exemplary starter pieces and keel structures are disclosed in Beery et al., U.S. Provisional Patent Application Ser. No. 62/248,990. Once the part 200 is fully printed, the part 200 rests on the supports 206, so the part 200 is easily and quickly removable from the supports 206, as it is simply resting on but not permanently or semi-permanently connected to the supports 206. FIG. 6 shows an enlarged portion 502 of FIG. 5, in which the supports 206 support part 200, where the lower surface 201 of part 200 is supported at contact areas 304 of supports 206.

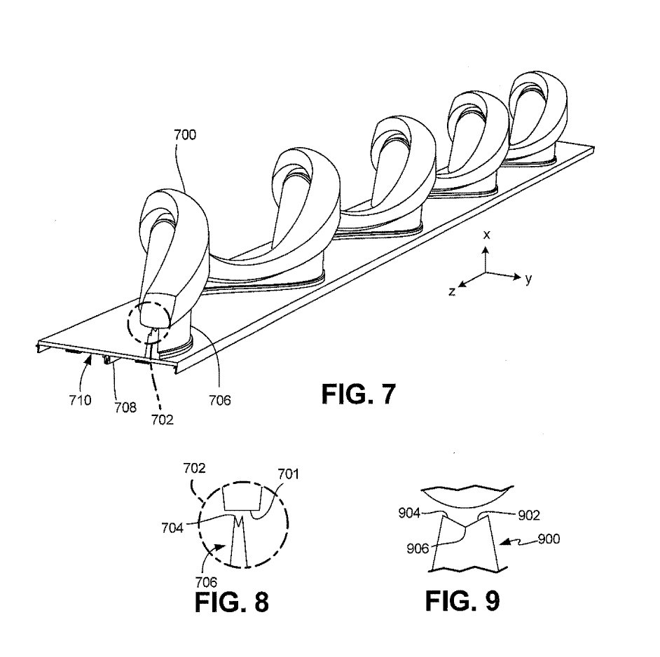

FIG. 7 illustrates an embodiment of a part 700 and support 706. Part 700 is a part that is sufficiently narrow, e.g., having a width less than 10 inches. Accordingly, a single gravitational support 706 is used for gravitational support of the part 700. With parts narrower than approximately 10 inches, a single support 706 is built running along the part 700 for gravitational support following a line along the bottom of the part 700 below the center of gravity of the part at that Z location. In an embodiment using a single support, if the pattern of the part shifts enough in X and Y to require geometric supports, then the single support 706 is likely also to use geometric support. Such a geometrically supported gravitational support still remains physically separated from the part being built. However, the use of a single gravitational support is not limited to a part having a width of less than ten inches. Further, the geometrically configured gravitational support 706 may be used instead of the support 206 or in combination with the support 206 depending upon the configuration of the part being printed.

FIG. 8 shows an enlarged portion 702 of FIG. 7, in which the part 700 is supported by the gravitational support 706. In this configuration, the lower surface 701 of part 700 is supported at contact areas 704 of support 706.

FIG. 9 shows another embodiment of a support 900 that supports a curved or other geometric configuration of a part, in which the support 900 is wider than supports 206 and 706, and which comprises a pair of upper faces 902 and 904 angled from a vertex 906, into which the curved portion of a part can rest. The support 900 assists in part stability against lateral movement, while still not being in permanent or semi-permanent contact with the part or portion thereof. It should be understood that for different geometries, different support top geometries may be used without departing from the scope of the disclosure.

Determining a location and placement for gravitational supports such as supports 206 and 706 is accomplished in one embodiment by identifying a width of the part to be built. If the width exceeds approximately 10 inches, then gravitational supports are indicated at about five inch intervals. If the width is less than approximately 10 inches, then a center of gravity location in Z is determined for the part, and the gravitational support is indicated just below that center of gravity along the Z axis of the part.

A computer module or software program in one embodiment receives or generates a digital file containing parameters for a part to be built. A width is determined for the part. If the width is greater than approximately 10 inches, locations and geometries of a plurality of gravitational supports spaced along the Y axis are generated using the geometry of the part. Then, a known or determined orientation and geometry with respect to starter pieces, a print foundation, and a keel structure (such as those described elsewhere herein) are determined, and the computer module or software, with or without operator assistance or manipulation, generates a digital representation of the gravitational support structure to build to provide gravitational supports, such as supports 206 or 706, that will support, without permanent or semi-permanent contact, the part that is to be built. In some embodiments, a starter piece such as starter pieces described in US Patent Publication 2014/0048981 and U.S. Provisional Patent Application Ser. No. 62/248,980 is used with the embodiments of the present disclosure as a base for the gravitational supports 206, 706.

Various examples of the present disclosure may be embodied in a computer program product, which may include computer readable program code embodied thereon, the code executable to implement a method according to embodiments of the present disclosure. The computer readable program code may take the form of machine-readable instructions. These machine-readable instructions may be stored in a memory, such as a computer-usable medium, and may be in the form of software, firmware, hardware, or a combination thereof. The machine-readable instructions configure a computer to perform various methods of thread balancing and allocation, such as described herein in conjunction with various embodiments of the disclosure.

In a hardware solution, the computer-readable instructions are hard coded as part of a processor, e.g., an application-specific integrated circuit (ASIC) chip. In a machine-readable instruction solution, the instructions are stored for retrieval by the processor. Some additional examples of computer-usable media include static or dynamic random access memory (SRAM or DRAM), read-only memory (ROM), electrically erasable programmable ROM (EEPROM or flash memory), magnetic media and optical media, whether permanent or removable. Most consumer-oriented computer applications are machine-readable instruction solutions provided to the user on some form of removable computer-usable media, such as a compact disc read-only memory (CD-ROM) or digital video disc (DVD). Alternatively, such computer applications may be delivered electronically, such as via the Internet or the like.

It will be appreciated that embodiments of the present disclosure can be realized in the form of hardware, machine-readable instructions, or a combination of hardware and machine-readable instructions. Any such set of machine-readable instructions may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement embodiments of the present disclosure. Accordingly, embodiments provide a program comprising code for implementing a system or method and a machine readable storage storing such a program. Still further, embodiments of the present disclosure may be conveyed electronically via any medium such as a communication signal carried over a wired or wireless connection and embodiments suitably encompass the same.

Computer-readable storage media in various embodiments may include different forms of memory or storage, including by way of example semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs).

Computer-readable storage media can be internal or external to the system 100, and in various embodiments contains a computer program product having machine-readable instructions stored thereon adapted to cause a processor in a controller such as controller 130 or in computer 140 to perform one or more methods described above.

Although the present disclosure has been described with reference to preferred embodiments, workers skilled in the art will recognize that changes may be made in form and detail without departing from the spirit and scope of the disclosure.

What is claimed is:

1. A method of printing a three-dimensional part in a horizontal additive manufacturing system, comprising:
printing the three-dimensional part in a layer-by-layer manner in a substantially vertical build plane; and
printing a support structure below the three-dimensional part in the substantially vertical build plane, wherein the three-dimensional part and the support structure are physically separated in the build plane, and wherein the support structure is configured to support the three-dimensional part during printing as the part is elongated.

2. The method of claim 1, wherein the physical separation between the three-dimensional part and the support structure is configured to be sufficient that the support structure and the three-dimensional part remain separate on cooling.

3. The method of claim 1, and further comprising generating a geometry for the support structure, wherein generating comprises:
determining a width of the three-dimensional part to be printed;
generating geometry for a plurality of support structures at selected spaced apart distances when the three-dimensional part has a build width greater than a selected width; and
generating geometry for a single support when the three-dimensional part has a build width less than the selected width.

4. The method of claim 1, wherein for a three-dimensional part having a build width greater than the selected width, printing a support structure comprises printing a plurality of support structures at the selected spaced apart distances.

5. The method of claim 1, wherein for a three-dimensional part having a build width less than the selected width, printing a support structure comprises printing a single support structure.

6. The method of claim 1, and further comprising printing the support structure with a geometric support supporting the support structure with at least a contact point when the three-dimensional part has a configuration that may move relative to a print axis.

7. The method of claim 1, wherein printing a support structure comprises printing the support structure using a starter piece structure on which the substantially vertical build plane rests as a base for the support structure.

8. An additive manufacturing system for printing three-dimensional parts, the system comprising:
a print head configured to print a part material along a non-vertical printing axis and in a substantially vertical print plane;
a non-horizontal print foundation configured to receive the printed part material from the print head to produce the three-dimensional part in a layer-by-layer manner;
a drive mechanism configured to index the print foundation along the non-vertical printing axis; and
a controller operably coupled to control the print head and the drive mechanism, the controller further configured to cause the print head to print the part in the build plane according to a method comprising:
printing a support structure in the build plane below the part on the non-horizontal print foundation, wherein the part and the support structure are physically separated in the build plane, and wherein the support structure is configured to support the part as the part is elongated during printing.

9. The additive manufacturing system of claim 8, wherein the physical separation between the three-dimensional part and the support structure is configured to be sufficient that the support structure and the three-dimensional part remain separate during cooling.

10. The additive manufacturing system of claim 8, wherein the controller is further configured to generate a geometry for the support structure by determining a build width of the three-dimensional part to be printed, generating geometry for a plurality of support structures at selected spaced apart lateral distances when the three-dimensional part has a build width greater than a selected width, and generating geometry for a single support when the three-dimensional part has a build width less than the selected width.

11. The additive manufacturing system of claim 8, wherein the controller is further configured to print a support structure by printing a plurality of support structures at the selected spaced apart lateral distances when a three-dimensional part being printed has a build width greater than the selected width.

12. The additive manufacturing system of claim 8, wherein the controller is further configured to print a single support structure when the three-dimensional part being printed has a build width less than the selected width.

13. The additive manufacturing system of claim 8, and wherein the controller is further configured to print the support structure using a starter piece structure on which the substantially vertical build plane rests as a base for the support structure.

14. A computer program product, comprising a non-transitory computer usable medium having a computer readable program code embodied therein, the computer readable program code adapted to implement a method for printing in a horizontal additive manufacturing system, by printing a three-dimensional part in a layer-by-layer manner in a substantially vertical build plane, and printing a support structure below the part in the substantially vertical build plane, wherein the part and the support structure are physically separated in the build plane, and wherein the support structure is configured to support the part as the part is elongated during printing.

15. The computer program product of claim 14, wherein the physical separation between the three-dimensional part and the support structure is configured to be sufficient that the support structure and the three-dimensional part remain separate on cooling.

16. The computer program product of claim 14, and further comprising generating a geometry for the support structure, wherein generating comprises:
determining a width of the three-dimensional item to be printed;

17. The computer program product of claim 14, wherein for a three-dimensional part having a build width greater than a selected width, printing a support structure comprises printing a plurality of support structures at selected spaced apart lateral distances.

18. The computer program product of claim 14, wherein for a three-dimensional part having a build width less than the selected width, printing a support structure comprises printing a single support structure.

19. The computer program product of claim 14, and further comprising printing the support structure with a geometric support supporting the support structure with at least a contact point when the three-dimensional part has a configuration that may move relative to a print axis.

20. The computer program product of claim 14, wherein printing a support structure comprises printing the support structure using a starter piece structure on which the substantially vertical build plane rests.
